(19) United States
(12) Patent Application Publication
(10) Pub. No.: US 2026/0319207 A1
(43) Pub. Date: Oct. 15, 2026

(54) Module Assembly, Carrier Unit and Carrier Arrangement for Fibre-Optic Distributor Technology

(71) Applicant: ROSENBERGER-OSI GMBH & CO. OHG, Augsburg (DE)

(72) Inventors: Luis Ernesto Bruecher Bender, Augsburg (DE); Danny Heimer, Augsburg (DE); Sven Schlomka, Augsburg (DE); Benjamin Weigand, Augsburg (DE); Haraki Mayr, Augsburg (DE)

(21) Appl. No.: 19/117,196

(22) PCT Filed: Jul. 19, 2023
(86) PCT No.: PCT/EP2023/070033

§ 371 Date: Mar. 31, 2025

(30) Foreign Application Priority Data
Oct. 7, 2022 (EP) 22200401.2

(51) Int. Cl. G02B 6/44

(52) U.S. Cl. CPC G02B 6/4452

(57) ABSTRACT

A module assembly for fiber-optic distribution for a carrier unit, having a central region and a center axis oriented in the installation direction. Side regions of the module assembly are adjacent the central region, on opposite sides, of the center axis and each have a side wall. One of the side walls has a curved or multi-step progression which changes the lateral distance to the center axis such that the side wall forms an elevation/depression. One of the side walls follows an imaginary bent curve which influences the distance of the side wall from the center axis. The side wall has plural points of contact with the imaginary bent curve. One of the side regions is rigid and can interact with elastic side regions of the module assembly; or is elastic to interact with rigid side regions to apply an axial clamping force that acts perpendicular to the center axis.

The invention relates to a module assembly for the fiber-optic distribution industry, which can be mounted along a mounting direction in a slot in a separate carrier unit, according to the precharacterizing clause of claim 1.

The invention also relates to a carrier unit for the fiber-optic distribution industry, having a carrier plate, which has at least one slot for at least one module assembly in each case, according to the precharacterizing clause of claim 11.

The invention further relates to a carrier arrangement having a carrier unit and at least one module assembly mounted in a slot.

In computing centers, carrier units, in particular individual trays or even “patch panels”, are used to produce and distribute data connections, e.g. via network cables, telephone cables or glass fiber cables. In practice, several patch panels are often installed at various vertical levels in a common distribution frame (also referred to as a “rack”).

Such a patch panel generally comprises at least one interface having a certain number of terminals or plug connectors which are either individual or grouped into modules or module assemblies (also referred to as “cassettes”). Such module assemblies or cassettes typically have a front interface with one or more first optical connectors (e.g. plug connectors), and a rear interface with one or more second optical connectors (e.g. plug connectors). Often, the number of first connectors of the input-side interface is greater than the number of second connectors of the output-side interface, with the individual connections within the module assembly being distributed accordingly between the two interfaces.

For the assembly of the individual module assemblies on a common carrier unit, two concepts in particular are known from the prior art.

One option is what is referred to as front frame based systems, in which the carrier unit has a front mounting frame, which has recesses for the respective module assemblies, and also punched holes for securing the outer housing of the module assembly. Such a concept is naturally associated with a long mounting time, since a multiplicity of manual screwing or riveting operations required for fastening the individual module assemblies in the mounting frame.

The substantial disadvantage of front frame based systems can be seen, however, in the limited accessibility and/or mountability, since the carrier units in such a system can usually only be fitted with module assemblies on one side, i.e. in particular exclusively from the front and not alternatively also from the rear.

Rail-based systems are an alternative. For this purpose, the carrier unit has individual rail guides and latching points for the module assemblies. As an example, reference should be made to EP 2 995 981 A2, in which various types of rail guides are proposed. Owing to the flexible extensibility of the individual module assemblies, a rail-based system does indeed afford advantages over an immovable, front frame based fastening in terms of the mounting and use of the carrier arrangement, but at the same time requires an elaborate and complex design of the carrier unit and the module assemblies.

For technological background, reference is furthermore also made to US 2019/0121046 A1, which relates to cassettes for the fiber-optic distribution industry, with spring clamping of the bracket which is designed such that it latches into a square-shaped cavity in the side of a cassette.

In view of the known prior art, it is the object of the present invention to provide a module assembly for the fiber-optic distribution industry, with an alternative mounting option, which is preferably technically easy to realize and convenient for the engineer, in a slot in a corresponding carrier unit.

The present invention is also based on the object of providing a carrier unit for the fiber-optic distribution industry, with an alternative mounting option, which is preferably technically easy to realize and convenient for the engineer, for a corresponding module assembly in a slot in the carrier unit.

It is also an object of the invention to provide a carrier arrangement consisting of a carrier unit and at least one module assembly, with an alternative mounting option, which is preferably technically easy to realize and convenient for the engineer, for the module assembly in a slot in the carrier unit.

The object is achieved for the module assembly by the features of claim 1 and for the carrier unit by claim 11. With regard to the carrier arrangement, the object is achieved by the features of claim 18.

The dependent claims and the features described below concern advantageous embodiments and variants of the invention.

A module assembly for the fiber-optic distribution industry, which can be mounted along a mounting direction in a slot in a separate carrier unit, is provided.

The module assembly has a center region through which a central axis or center axis oriented in the mounting direction runs. The module assembly also has two side regions, each of which is connected to the center region opposite each another relative to the center axis and each of which has at least one side wall.

The center region runs preferably symmetrically in relation to its center axis. The center region can be, for example, an imaginary, rectangular region of the module assembly, which (with respect to the center axis) merges on both sides in one piece or optionally also in a plurality of pieces into the side regions. The design of the module assembly, i.e. the center region and the two side regions, can be formed overall symmetrically along the center axis. However, it can also be provided that only the (imaginary) center region runs symmetrically and the side regions introduce an asymmetry (in relation to the center axis) into the module assembly. Preferably, the side walls are arranged symmetrically about the center axis or are arranged equidistantly from the center axis.

The center axis is preferably a longitudinal axis of the module assembly.

According to the invention, it is provided that at least one of the side walls has, at least in certain sections along the center axis, a curvy and/or stepped (in particular multi-step) profile changing the lateral distance from the center axis such that the at least one side wall forms at least one elevation and/or depression (can optionally also be referred to as protrusion and/or setback portion) for form-fitting mounting in the slot in the carrier unit.

Thus, at least one curvy and/or multi-step elevation and/or depression can be formed on the side walls along the center axis, optionally also a plurality of elevations and/or depressions. The elevations and/or depressions can be formed, for example, by convex or concave profiles of the side walls. Complex profiles of the side walls are also possible, for example if the curve profile of the side wall has a plurality of vertices or a plurality of radii. A radius of the side walls can be constant or variable along the side wall.

It can be provided in particular that at least one of the side walls along at least one of its directions of extent at least substantially follows an imaginary curved curve, the amplitude of which influences the distance of the corresponding side wall from the respective other side wall or from the center axis.

Owing to the fact that the side walls of the module assembly are not cuboidal or linear, but for example follow an elliptical or other non-rectilinear profile, the module assembly can be suitable for a technically easily realizable, form-fitting fastening in a corresponding slot in a corresponding connection partner. The proposed design of the module assembly in its side regions can permit a particularly simple, rapid and convenient mounting option for the module assembly in a carrier unit. Complicated rail systems can be dispensed with.

In an advantageous embodiment of the invention, it can be provided that the side walls have a substantially flat profile, preferably in each case being formed in one piece.

The side walls preferably have a flat outer circumferential surface. For example, the side walls of the module assembly can have a convexly arched outer circumferential surface. However, a concavely arched outer circumferential surface, or other curve profiles, can also be provided.

A flat profile of the side walls can be technically particularly easy to realize. In particular, webs, shoulders, longitudinal grooves, etc., which may usually be required, for example, for a rail guide, can be dispensed with.

The side walls preferably extend in each case substantially in two directions of extent. The first direction of extent is preferably a longitudinal extent (in particular in the mounting direction) and the second direction of extent is preferably a transverse extent oriented perpendicularly to the longitudinal extent or orthogonally to the longitudinal extent or mounting direction, in particular the shorter of the two transverse extents, i.e. for example, corresponding to the overall height of the module assembly.

It can be provided that the side wall forms the distance-changing profile—in relation to the center axis—along the first direction of extent, i.e. along the mounting direction.

It can alternatively or additionally also be provided that the side wall forms the distance-changing profile—in relation to the center axis—along the second direction of extent, i.e. transversely with respect to the mounting direction.

In a particularly advantageous development of the invention, however, it can be provided that the lateral distance from the center axis of the at least one side wall along the mounting direction and also transversely with respect to the mounting direction changes (i.e. along the above-mentioned first direction of extent and the second direction of extent).

For example, it can be provided that the side walls of the module assembly are each shaped convexly in the mounting direction and also transversely with respect to the mounting direction (along the overall height) and a corresponding slot in a connection partner (in particular in a carrier unit also described below) is shaped in complementary fashion, i.e. is shaped concavely in two corresponding directions of extent, and therefore the module assembly can be mounted in a form-fitting manner in the slot.

Preferably, the two side walls of the module assembly follow a respectively imaginary curved curve or have the above-mentioned curvy and/or multi-step profile. In the context of the invention, however, it may also be sufficient in certain cases if only one of the side walls has the curvy and/or multi-step profile.

Insofar as both side walls have a respective curvy or multi-step profile, the side walls preferably extend symmetrically with respect to the center axis of the center region such that the profile of the respective side wall is mirrored at the center axis.

According to one embodiment of the invention, it can be provided that the side wall follows the curved curve approximately uniformly, in stepped form, in particular in multi-step form, or polygonally.

Preferably, the profile of the side wall corresponds to the profile of the imaginary curved curve. However, the profile of the side wall may also deviate from the profile of the imaginary, curved curve, for example if the side wall has a multi-step profile. In this case, the side wall has as many points of contact and/or intersecting points as possible with the imaginary curved curve. For example, at least two intersecting points or points of contact, preferably at least four, furthermore preferably at least six, for example even eight, ten or even more points of contact may be provided, with it also being possible to provide an odd number of points of contact, i.e., for example, three, five, seven, nine or even more points of contact.

Any desired curvy, stepped and/or polygonal cross-sectional profile of the side walls can be provided.

According to a development of the invention, it can be provided that the at least one elevation and/or depression is formed in a central portion spaced apart from the end portions of the side walls.

The end portions between which the side walls extend in each case are preferably respective ends of the module assembly, but optionally also a respective portion in the region of the corresponding end.

In particular, it can be provided that the at least one elevation and/or depression or the vertex or saddle point also mentioned below is formed centrally or at least substantially centrally between the two end portions, i.e. for example, at least in the central third of the side wall.

In a particularly advantageous embodiment of the invention, it can be provided that the elevation and/or depression (in particular precisely one elevation or depression) extends over the entire side wall, i.e. in particular over the complete extent of the side wall between the two ends or end portions. This can result, for example, in a bulbous/elliptically arched side wall (convexly or concavely).

According to a development of the invention, it can be provided that the at least one side wall for changing the lateral distance along the center axis has a continuous profile.

A profile of the side wall interrupted along the center axis can optionally also be provided. For example, a plurality of side wall segments, which together form the side wall and respective curvy and/or multi-step profiles in certain sections, can be provided.

In one embodiment, the elevation and/or depression can be formed by at least one vertex or saddle point of the curvy profile, preferably by a primary vertex of a global extremity of the curvy profile of the side wall.

In a development of the invention, it can be provided that the at least one side wall forms an elliptical profile, preferably a concave or convex profile, in a direction orthogonal to the mounting direction.

Therefore, in particular, a profile of the side walls with precisely one vertex or saddle point can be provided, in particular with a preferably central vertex or saddle point spaced apart from the end portions of the side walls, in order to form the elevation or depression.

The overall height of the side walls of the module assembly can preferably be configured to a known standard dimension for fiber-optic module assemblies (what is referred to as a “rack unit”, RU). The overall height of the side walls may however be arbitrary in principle. Insofar as a “rack unit” is referred to above and below, this is a unit of measurement which is typically used for electronic housings and which is familiar to a person skilled in the art and is standardized, and which is used in particular with regard to device housings for installation in 19-inch racks or 19-inch distribution frames. One rack unit corresponds to 1% inches or 44.45 millimetres.

The module assembly, in particular the side walls of the module assembly, can be formed from a plastic or a metal material. Combinations of plastic or metal can optionally also be provided. Optionally, biocompatible materials, for example biopolymers, can also be provided. In particular, fire-retardant materials can also be used.

The module assembly an have an outer housing, wherein the side walls preferably form a part of the outer housing. The outer housing of the module assembly can be designed in the manner of a frame, in particular can be completely closed along its circumference. The outer housing can optionally, however, also be open on one or more sides. The two side walls can preferably be connected to each other at their respective ends via a front and/or rear end panel. However, it can also be provided that the outer housing only has a base plate and the two side walls, which are only optionally, but not necessarily, connected to each other.

The module assembly preferably has at least one fiber-optic component or at least provides the option of receiving a fiber-optic component. In particular, the center region can receive at least one fiber-optic component.

The outer housing of the module assembly can have a base plate and/or a cover plate to adequately protect the fiber-optic components of the module assembly.

The module assembly can also be referred to as a “fiber-optic module” or “fiber-optic cassette”. Typically, such module assemblies are provided for receiving in a carrier unit, with it being possible for a plurality of module assemblies to be mounted in a common carrier unit.

The module assembly can have a front interface with one or more optical connectors (e.g. plug connectors).

The module assembly can have a rear interface with one or more second optical connectors (e.g. plug connectors).

The number of first connectors of the front interface is preferably greater than the number of second connectors of the rear interface. Within the module assembly, especially within the outer housing, individual connections can be distributed between the two interfaces.

The invention also relates to a carrier unit for at least one module assembly for the fiber-optic distribution industry (in particular the aforementioned module assembly), having a carrier plate, which has at least one slot for at least one module assembly each, and having in each case a center axis oriented in a mounting direction of the module assembly.

According to the invention, the carrier unit in each case has a fastening device connected to the carrier plate for the form-fitting fastening of the module assembly in the at least one slot. The fastening device has two fastening brackets, which are each formed at a lateral end of the slot relative to the center axis. Each of these laterally extending or lateral fastening brackets in each case has a side wall, preferably laterally delimiting the slot.

It should be mentioned at this juncture that, within the scope of the present description, the side wall or the side walls of the carrier unit may also be referred to as “carrier side walls” and the side walls of the module assembly as “module side walls”. In principle, features of the carrier side walls and of the module side walls can be interchangeable, unless otherwise mentioned and if this is not technically excluded. This applies, for example, to the distance-changing curves with respect to the center axis (e.g. convex vs. concave), as described above and below, the elasticity of the side walls or the material of the side walls. Insofar as only one “side wall” is mentioned above and below, the details may refer to a module side wall and/or to a carrier side wall.

According to the invention, it is provided that at least one of the side walls of the carrier unit has, at least in certain sections along the center axis, a curvy and/or multi-step profile changing the lateral distance from the center axis such that the at least one side wall forms at least one elevation and/or depression for form-fitting mounting of the module assembly in the slot.

The slot is preferably formed between the carrier side walls, the side walls being oriented horizontally with respect to the carrier plate in order to form a respective horizontal slot delimited by the carrier plate at the bottom (preferably). The center axis of the slot can thus run parallel to the carrier plate or its main surface.

In principle, however, it can also be provided that the slot is oriented vertically with respect to the carrier plate or runs obliquely, along any desired angle with respect to the carrier plate, in order to enable the module assemblies to be accommodated orthogonally in the direction of the carrier plate or obliquely in the direction of the carrier plate. The center axis of the slot can thus run in angular to orthogonal form to the carrier plate or its main surface (e.g. at an angle of up to about 5°, 10°, 15°, 20°, 25°, 30°, 35°, 40°, 45°, 50°, 55°, 60°, 65°, 70°, 75°, 80°, 85°, 90° or more).

It should be mentioned at this juncture that the cover plate and/or base plate can optionally also have spring elements, i.e. can form a part of the slot in the carrier unit. In this case, the cover plate and/or base plate can also be understood as meaning “side walls” within the scope of the present description.

The carrier unit preferably has at least one fiber-optic component or provides at least the possibility of receiving a fiber-optic component.

The carrier unit is preferably used for receiving a plurality of module assemblies, for example for receiving two, three, four, five, six, seven, eight, nine, ten or even more module assemblies.

The carrier unit can be designed, for example, as a tray of a distribution frame or generally as a “patch panel”. Optionally, the carrier unit, especially if it is designed as a tray, can have a mounting frame, which optionally has components of a rail guide on the outer sides. In addition to the carrier plate, the carrier unit can optionally also have a cover plat in order to sufficiently protect the module assemblies received in the carrier unit.

Openings for the passage of fiber-optic lines can preferably be formed in the carrier plate of the carrier unit. It can also be provided that the carrier unit is open at the rear and/or front in order to permit advantageous accessibility to the front interface and/or rear interface of the module assemblies. Optionally, a front and/or rear cover plate or end panel can be provided, for example, a closable (e.g. pivotable) cover plate to optionally restrict accessibility to the front and/or rear interface of the module assemblies fastened on the carrier unit.

According to the invention,
a) at least one of the side regions of the module assembly is formed rigidly and at least one of the fastening brackets of the carrier unit is formed elastically such that the side regions of the module assembly and the fastening brackets are capable of interacting with each other in such a way (or interact with each other in such a way) as to apply an axial clamping force to the module assembly, which clamping force acts in the direction of a transverse axis which runs perpendicular to the center axis of the slot and which extends laterally through the slot between the fastening brackets; or
b) at least one of the side regions of the module assembly is formed elastically and at least one of the fastening brackets of the carrier unit is formed rigidly such that the side regions of the module assembly and the fastening brackets are capable of interacting with each other in such a way (or interact with each other in such a way) as to apply an axial clamping force to the module assembly, which clamping force acts in the direction of a transverse axis which runs perpendicular to the center axis of the slot and which extends laterally through the slot between the fastening brackets; or
c) at least one of the side regions of the module assembly is formed elastically and at least one of the fastening brackets of the carrier unit is formed elastically such that the side regions of the module assembly and the fastening brackets are capable of interacting with each other in such a way (or interact with each other in such a way) as to apply an axial clamping force to the module assembly, which clamping force acts in the direction of a transverse axis which runs perpendicular to the center axis of the slot and which extends laterally through the slot between the fastening brackets.

The axial clamping force can advantageously serve to secure the module assembly in its mounted state within the slot, for example by the axial clamping force acting as a counterforce to an axial extension force such that the module assembly strives to pass into the center or to another defined axial position within the slot. Accordingly, the axial clamping force can advantageously also serve to assist the mounting of the module assembly in the slot by the axial clamping force acting as a guide force such that the module assembly is automatically moved from a preassembly position into the center or to another defined axial position within the slot.

In a development, it can be provided in particular that the transverse axis runs through a center of the slot. In this case, the axial clamping force advantageously acts towards the central axial position in the slot. This position can be the final mounting position of the module assembly in the slot. However, it can also be provided that an axial final mounting position differing from the central axial position is provided—in this case, the transverse axis can be correspondingly spaced apart from the center of the slot, for example can be offset to the rear side of the slot.

It can be provided that the module assembly in the mounting position or target position of the module assembly within the slot (for example in the center of the slot) is accommodated free of forces with respect to the axial clamping force, i.e. that the axial clamping force does not act in this mounting state, but rather only in the states of the module assembly that are deflected from the mounting position. However, it can also be provided that. even in the fully mounted state of the module assembly, the axial clamping force still acts on the module assembly—the elastic means of the side regions and/or fastening brackets can be correspondingly mechanically pre-loaded in the mounted state of the module assembly.

It should be mentioned at this juncture that the at least one side region and/or the at least one fastening bracket can additionally also be designed to apply a lateral clamping force, or a lateral clamping force acting in the direction of the center axis of the slot, to the module assembly. In this way, an advantageous (automatic) centering of the module assembly can take place, in particular with the module assembly being introduced obliquely into the slot.

In an advantageous development of the invention, it can be provided that a spring force emanating from the elastically formed side regions and/or from the elastically formed fastening brackets is oriented more specifically in the direction of the axial clamping force at at least one end portion of the side region or of the fastening bracket than in a central portion, in which the spring force is preferably oriented exclusively orthogonally to the axial clamping force. The direction vector of the spring force can therefore rotate from an orthogonal orientation to the central axis in the central portion of the side region or of the fastening bracket along the longitudinal axis of the side region or fastening bracket as far as the end portions (at maximum to a parallel orientation to the central axis). This can be made possible in particular by a curved, for example convex or concave design, of the elastic means and/or a corresponding distribution of forces of the elastic means along the longitudinal axis. At the end portions, the spring force can therefore preferably deploy its greatest effect in the direction of the axial clamping force, whereas the action in the direction of the lateral clamping force can be the smallest. The vectorial distribution between an axial and a lateral vector component of the spring force can therefore be specifically predetermined along the longitudinal axis of the side region or of the fastening bracket and can be variable. Preferably, in the central portion, a greater lateral clamping force and a smaller axial clamping force act than at the end portions, with the vectorial distribution of the spring force between an axial and a lateral vectorial component of the clamping force between the central portion and the end portions preferably being able to change continuously.

It can be provided that at least one of the elastically formed side regions of the module assembly has a spring element running along the corresponding side wall, wherein the spring element can be assembled in one piece or, for example, from a plurality of individual springs arranged along the side wall of the module assembly.

The spring force or the elastic restoring force of the elastic side regions of the module assembly preferably acts away from the center axis in the event of a compression occurring during the mounting of the module assembly in the slot. The spring force or the elastic restoring force of the elastic fastening brackets of the carrier unit preferably act towards the center axis in the event of a compression occurring during the mounting of the module assembly in the slot.

For example, the side walls and/or fastening brackets can be formed elastically using an elastomer as the basic material or can have one or more elastic elements, for example leaf springs.

The deformability or the elasticity can be selected in such a manner that a sufficient holding force for the module assembly in the corresponding slot of the connecting partner is provided, and/or that the side regions or fastening brackets can sufficiently reversibly bend during the mounting without undergoing an (irreversible) plastic deformation.

In an advantageous development of the invention, it can be provided that the carrier plate has a plurality of slots arranged next to one another, preferably at an equidistant spacing and/or with an identical slot width in each case.

As an alternative to an equidistant arrangement of the slots on the carrier plate, any desired irregular or flexible spacing and respective slot width of the slots can be provided. It can also be provided that the slot width of the slots and/or the spacing of individual slots can be adjusted as required, for example by individual carrier side walls on the carrier plate being offset. In this way, different types of fiber-optic module assemblies can be combined modularly on a common carrier unit. The multiple slots can thus be designed for accommodating module assemblies of different widths in each case or can be arranged on the carrier unit.

It can preferably be provided that in each case two directly adjacent slots have common side wall. Alternatively, however, the adjacent slots can also be formed separately from one other, with each slot therefore having its own side walls.

In a development of the invention, it can be provided that the slot is designed to allow a mounting of the module assembly in the horizontal direction along the carrier plate.

The insertion or the removal of a module can preferably be carried out from the front and back of a slot in the same way.

Alternatively or—preferably—additionally, it can be provided that the slot is designed to allow mounting of the module assembly in the vertical direction, in the direction of the carrier plate.

Preferably, the side walls of the carrier unit enclose the side walls of the module assembly both in top view and in frontal view, and therefore securing of the module assembly can take place both in the mounting direction and in a vertical direction orthogonally oriented thereto.

For mounting the module assembly in the horizontal direction, i.e. along the carrier plate, the slot or the slot-forming carrier unit can preferably be open at at least one, in particular at both end portions. Preferably, the slot comprises only the two side walls. This allows the module assembly to be inserted at the front and/or rear. Insertion on one side (for example, only from the front or only from the rear) can also be provided, for example, if the slot is U-shaped.

In order to allow insertion in the vertical direction, i.e. in the direction of the carrier plate, it can be provided that the slot is open on the side facing away from the carrier plate. In this way, the module assembly can be inserted “from above” into the slot.

Preferably, the module assemblies are secured in a form-fitting manner not only horizontally, but also vertically to the mounting direction. In particular (but not exclusively) in this case, a cover plate of the carrier unit can be dispensed with, which can be of advantage for a particularly dense, stacked arrangement of carrier units, since the possibility of saving on the individual cover plates favours minimizing the overall height of individual carrier units.

In an advantageous development of the invention, it can be provided that at least one of the fastening brackets is elastic.

Preferably, at least one of the fastening brackets has at least one spring element extending along the corresponding side wall or is formed elastically at least in certain sections (for example, using an elastomer as the base material). Particularly preferably, the side wall is formed by at least one leaf spring or has at least one leaf spring.

The spring element preferably acts elastically in the direction of the respective opposite side wall.

The mounting and/or removal of the module assembly into or out of the corresponding slot in the carrier unit can be carried out by overcoming the holding force or clamping force of the spring elements or leaf springs by a correspondingly strong compressive or tensile force being applied.

The inclusion of an elastic component in the fastening bracket may be advantageous to provide an advantageous possibility for inserting the module assembly and to optionally also apply a force-fitting connection between the slot and module assembly or at least a retaining force to the module assembly in the fastened state. It may in principle already be sufficient if either the side regions of the module assembly or the fastening brackets of the carrier unit are elastic. Optionally, however, it is also possible for both connection partners or neither of the connection partners to be elastic or have a spring element.

A particular advantage in terms of mounting when an elastic component is included in the fastening bracket can a so be seen in the fact that the module assembly can then also be introduced into the slot in angular or oblique form. The centering of the module assembly within the slot can be carried out automatically by the spring forces as it is being introduced. An engineer therefore does not have to take particular care and the risk of damage to the module assembly or the carrier unit can also reduced. Furthermore, an introduction aid, such as a funnel-shaped housing design, can optionally be dispensed with, which can enable a more compact construction.

In a development of the invention, it can be provided that the spring element, in particular the leaf spring, is composed of a plurality of individual springs arranged along the side wall.

The fastening bracket, for example, the respective side wall of the slot, can thus also be formed by a plurality of individual spring elements, which are arranged vertically and/or horizontally next to one other, optionally spaced apart from one another.

The contact pressure with which the fastening brackets of the slot act on the side walls of the module assembly can preferably be optimized in dependence on the application, by a person skilled in the art. The realizable spring force of individual spring elements or the spring travel of individual spring elements can thus be variable, for example by selecting the leaf spring material, the leaf spring thickness and/or the leaf spring length.

In particular if a plurality of individual springs are provided and are distributed along the side wall, it can be of advantage to predetermine the magnitude and/or the direction of the spring force of the individual springs independently of one another. For example, individual springs in a front portion of the module assembly or of the slot can be designed to produce a higher spring force than individual springs in a rear portion of the module assembly—or vice versa. In this way, for example, the final mounting position of the module assembly within the slot can be defined and also predetermined independently of the center of the slot.

In order, in addition to a form-fitting fastening option, optionally also to permit the possibility of an increased frictional connection between the interconnected connection partners, the outer surface of the side walls can optionally have a corresponding surface structure, for example a corrugation or coating.

The slot can be completely closed along its circumference, or optionally, however, can also be open on one or more sides. The slot can therefore be U-shaped, for example. However, it can be provided in particular that the slot has only the two side walls, which are optionally, but not necessarily, connected to each other.

In an advantageous development of the invention, it can be provided that the fastening device is either formed integrally with the carrier plate (e.g. as a punched and bent part or injection-moulded part) or is fastened to the carrier plate (in a force-fitting, form-fitting and/or integrally bonded manner).

Insofar as the slot, in particular the side walls of the slot, for example the spring elements, are intended to be formed integrally with the carrier plate, the carrier plate, optionally the entire carrier unit, can preferably be produced as an injection moulded part or punched and bent part.

Insofar as the slot or the side walls of the slot are formed in multiple pieces with the carrier plate, these can be fastenable, for example, via pins, rivets or screws. A press fit or an integrally bonded connection, such as a welded connection, can also be provided.

Preferably, the side walls of the slots can be individually latched, pressed and/or screwed onto the carrier plate. The carrier plate can in particular have a connecting grid such that the side walls can be mounted at defined positions by an engineer.

In particular if a plurality of slots are arranged on a common carrier unit, they can also have different overall heights in order to receive fiber-optic module assemblies of different heights.

It should be mentioned at this juncture that a slot in the carrier unit can also be designed for receiving a plurality of -optic module assemblies (in the horizontal direction or in the longitudinal axis direction, i.e. “one behind another” or as a stack, i.e. “one on top of another”). In this case, at least one separate spring element is preferably provided for each module assembly. Preferably, however, a respective slot is provided for receiving precisely one module assembly.

The invention also relates to a carrier arrangement, comprising a carrier unit according to the statements above or below, and at least one module assembly, which is mounted in one of the slots, in particular according to the statements above and below.

The carrier arrangement according to the invention for the fiber-optic distribution industry comprises
a) a carrier unit, having a carrier plate, which has at least one slot for at least one module assembly each, which slot has a center axis oriented in a mounting direction of the module assembly, and having in each case a fastening device connected to the carrier plate for the form-fitting fastening of the module assembly in the at least one slot, wherein the fastening device has two fastening brackets, which are each formed at a lateral end of the slot relative to the center axis, wherein each fastening bracket in each case has a side wall facing into the slot, wherein at least one of the side walls of the respectively assigned fastening bracket has, at least in certain sections along the center axis, a curvy and/or multi-step profile changing the lateral distance from the center axis such that the at least one side wall forms at least one elevation and/or depression for form-fitting mounting of the module assembly in the slot, wherein at least one of the side walls of the respectively assigned fastening bracket along at least one of its directions of extent at least substantially follows an imaginary curved curve, the amplitude of which influences the distance of the corresponding side wall from the center axis, and wherein said side wall has at least four points of contact and/or intersecting points with the Imaginary curved curve, and
b) at least one module assembly which is mounted in one of the slots and can be mounted along a mounting direction in the slot in the separate carrier unit, with a center region through which a center axis oriented in the mounting direction runs, and two side regions, each of which is connected to the center region opposite each other relative to the center axis and each of which has a side wall, wherein at least one of the side walls of the module assembly has, at least in certain sections along the center axis, a curvy and/or multi-step profile changing the lateral distance from the center axis such that the at least one side wall forms at least one elevation and/or depression for form-fitting mounting in the slot in the carrier unit, wherein at least one of the side walls of the module assembly along at least one of its directions of extent at least substantially follows an imaginary curved curve, the amplitude of which influences the distance of the corresponding side wall from the center axis, and wherein said side wall has at least four points of contact and/or intersecting points with the imaginary curved curve, such that the module assembly (1) in its mounted state is received in a form-fitting manner within the fastening device (21).

With regard to the proposed carrier arrangement, it can be provided in particular that
a) at least one of the side regions of the module assembly is formed rigidly and at least one of the fastening brackets of the carrier unit is formed elastically such that the side regions of the module assembly and the fastening brackets are capable of interacting with each other in such a way (or interact with each other in such a way) as to apply an axial clamping force to the module assembly, which clamping force acts in the direction of a transverse axis which runs perpendicular to the center axis of the slot and which extends laterally through the slot between the fastening brackets; or
b) at least one of the side regions of the module assembly is formed elastically and at least one of the fastening brackets of the carrier unit is formed rigidly such that the side regions of the module assembly and the fastening brackets are capable of interacting with each other in such a way (or interact with each other in such a way) as to apply an axial clamping force to the module assembly, which clamping force acts in the direction of a transverse axis which runs perpendicular to the center axis of the slot and which extends laterally through the slot between the fastening brackets; or
c) at least one of the side regions of the module assembly is formed elastically and at least one of the fastening brackets of the carrier unit is formed elastically such that the side regions of the module assembly and the fastening brackets are capable of interacting with each other in such a way (or interact with each other in such a way) as to apply an axial clamping force to the module assembly, which clamping force acts in the direction of a transverse axis which runs perpendicular to the center axis of the slot and which extends laterally through the slot between the fastening brackets.

In the proposed manner, a fiber-optic module assembly can be releasably secured and centered on a carrier unit (for example, on a tray or fiber-optic distribution housing).

Overall, the module assembly or its outer housing is preferably designed such that it has a curved, in particular elliptical, preferably convex, shape in both frontal view and top view. In each case opposite elastic side walls of respective slots are preferably located on the carrier plate of the fiber-optic carrier unit, preferably in a discrete arrangement, with in particular two leaf spring pairs being provided per slot. The slots preferably correspond in their shape to the negative of corresponding side walls of the module assembly.

In a particularly preferred variant, the leaf springs of the slot, which are pretensioned in the direction of the inside of the slots, can be pushed aside by the curved shape of the module assembly—which preferably tapers in the direction of the front side and rear side—until the vertex of the elliptical module basic outline is located in the center of the leaf spring pairs. At this point, the leaf springs embrace in a form-fitting manner around the side walls of the module assembly and secure the module assembly by means of a contact pre sure defined by the pretensioning of the leaf springs.

In particular, the proposed combination of form-fitting connection and force-fitting connection makes it possible to dispense with an elaborate guide, such as a rail guide, for mounting a module assembly on the carrier unit. Advantageously, a pure clamping function can be provided between the carrier unit and the module assembly.

According to the invention, the insertion and removal of the individual fiber-optic module assemblies can be carried out simply, in particular conveniently and with a saving on time, and also reliably. In a minimalistic variant of the invention, preferably no additional components besides the respective curved side walls are necessary for the purpose of securing or fastening a module assembly in the carrier unit. In particular, it is possible to dispense with a complex rail guide or with screwing the module assembly into the carrier unit.

In an advantageous development of the invention, it can be provided that the side walls of the module assembly have at least substantially a complementary shape of the side wall of the respectively assigned fastening bracket such that the module assembly in its mounted state is accommodated in a form-fitting manner within the fastening device.

In particular, the slot can have a negative shape of the module assembly—or vice versa. In particular, however, a completely complementary shape is not important—a substantially complementary shape between the slot and the module assembly may possibly already be sufficient to provide a stable, form-fitting mounting option.

In particular, it can be provided that the curved curve of the side walls of the module assembly runs convexly and the curved curve of the side walls of the slot runs concavely. A convex shape of the module assembly and a concave design of the slot can be technically particularly easy to implement. If necessary, however, the module assembly may also be concave and the slot in the carrier unit may be convex.

In the case of convex side walls, the global extremity of the primary vertex is preferably a global maximum, but, in the case of concave side walls, it is preferably a global minimum of the curved curve.

Preferably, an at least approximately elliptical or fully elliptical profile of the side walls is provided.

In a development of the invention it can be provided that either the side region of the module assembly or the fastening bracket, which is assigned to the side region, of the fastening device is elastic.

In particular, it is therefore not absolutely necessary for the side walls of the module assembly and the fastening bracket to be elastic in each case.

According to a development of the invention, it can be provided that a slot width of the slots is greater than a width of the module assembly, for example is greater by at least 1%, is greater by at least 2%, is greater by at least 5%, is greater by at least 10%, is greater by at least 20%, is greater by at least 30%, is greater by at least 50% or is greater by at least 100%.

Within the scope of the invention, it is possible in a slot to receive even module assemblies having a width which is smaller than the module width which tends to be provided for the respective slot. Thus, for example, downward compatibility between various product generations of carrier units and module assemblies is made possible.

According to a development of the invention, it can be provided that the module assembly has a latching means and the fastening device of the carrier unit has a mating latching means in order to releasably latch the module assembly in at least one insertion position within the fastening device.

The latching means and mating latching means can be in particular a combination of a depression and an elevation. The depression can be a groove or a setback portion. The elevation can be, for example, a pin, bolt or web. Preferably, the latching means and/or mating latching means can be arranged on a spring-elastic element, such as a latching lever.

In principle, the module assembly and slot can also have a plurality of latching means and respective mating latching means to allow releasable latching in a plurality of insertion positions.

Preferably, latching is provided at least in the fully inserted or mounted position of the module assembly within the slot, but optionally also in one or more partially inserted intermediate positions.

In a particularly advantageous embodiment of the latching connection, it can be provided that the latching means of the module assembly and the mating latching means of the carrier unit are formed in each case at least substantially centrally between the two end portions, for example at the global vertex or saddle point of the side walls. It can be advantageous to provide only a minimum spring travel in the region of the latching connection in order to arrange the latching connection in as rigid a region as possible, since then the required locking force and unlocking force can be configured independently of the spring force and the spring travel.

Optionally, between the module assembly and slot or carrier unit, an end stop for the module assembly can be provided so that the module assembly cannot be pushed further into the slot beyond a certain position, i.e., for example, it also cannot be pushed out again from the rear of the slot.

By means of a specific adjustment of the side walls of the module assembly and of the slot, in particular by adjusting the spring elements, an automatic retraction mechanism can optionally also be provided. This means that the module assembly can also be automatically pulled into the fastening position in the slot.

Features which have been described in conjunction with one of the subjects of the invention, which are specifically the module assembly, the carrier unit and the carrier arrangement, can also be advantageously applied to the other subjects of the invention. Likewise, advantages specified in conjunction with one of the subjects of the invention can also be understood in relation to the other subjects of the invention.

In addition, it should be noted that expressions such as “comprising”, “having” or “with” do not exclude any other features or steps. Furthermore, expressions such as “a” or “the” that refer in the singular to steps or features do not exclude a plurality of features or steps—and vice versa.

In a puristic embodiment of the invention, it may however also be provided that the features introduced in the invention by the expressions “comprising”, “having” or “with” constitute an exhaustive list. Accordingly, in the context of the invention, one or more lists of features can be considered in self-contained form, for example respectively for each claim. By way of example, the invention can consist exclusively of the features specified in claim 1.

Note that terms such as or “second” etc. are used predominantly for the sake of distinguishability between respective or method features, and are not imperatively intended to indicate that features are mutually dependent or relate to one another.

It is furthermore emphasized that the values and parameters described in the present case also encompass deviations and fluctuations of ±10% or less, preferably ±5% or less, more preferably ±1% or less, and very particularly preferably ±0.1% or less, of the respectively stated value or parameter, if such deviations are not ruled out in practice in the implementation of the invention. The specification of ranges by way of start and end values also encompasses all values and fractions encompassed by the respectively stated range, in particular the start and end values and a respective mean value.

Exemplary embodiments of the invention will be described in detail hereinbelow with reference to the drawings.

The figures each show preferred exemplary embodiments in which individual features of the present invention are illustrated in combination with one another. Features of one exemplary embodiment may also be implemented separately from the other features of the same exemplary embodiment, and may accordingly be readily combined by an expert to form further useful combinations and sub-combinations with features of other exemplary embodiments.

Elements of identical function are denoted by the same reference signs in the figures.

In the figures, in each case schematically:

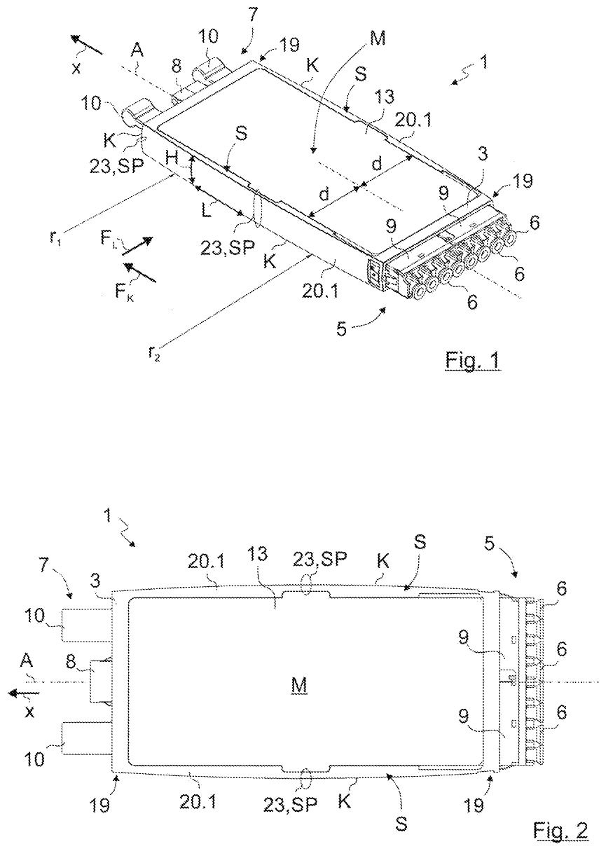

FIG. 1 shows a perspective illustration of a module assembly for mounting in a carrier unit for the fiber-optic distribution industry according to an exemplary embodiment of the invention;

FIG. 2 shows the module assembly of FIG. 1 in a top view;

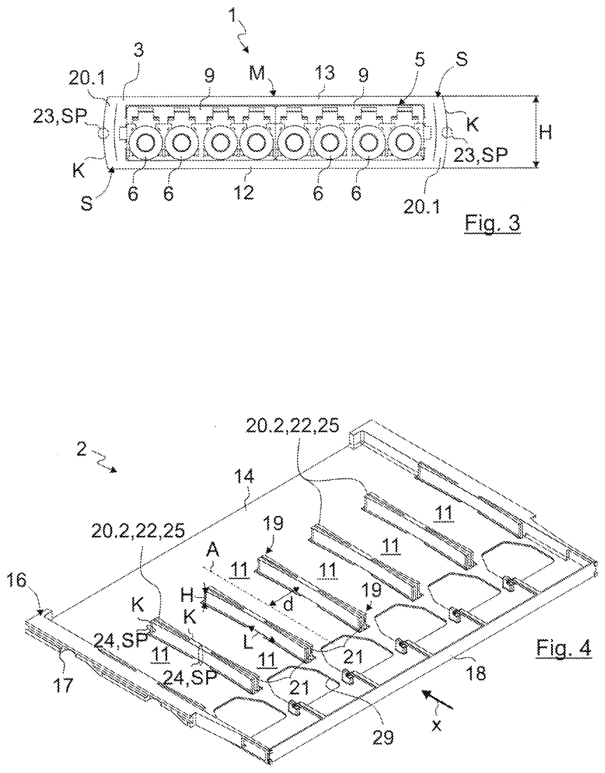

FIG. 3 shows the module assembly of FIG. 1 in a front view of the front interface;

FIG. 4 shows a perspective illustration of a carrier unit for a plurality of module assemblies for the fiber-optic distribution industry, with a plurality of slots according to an exemplary embodiment of the invention;

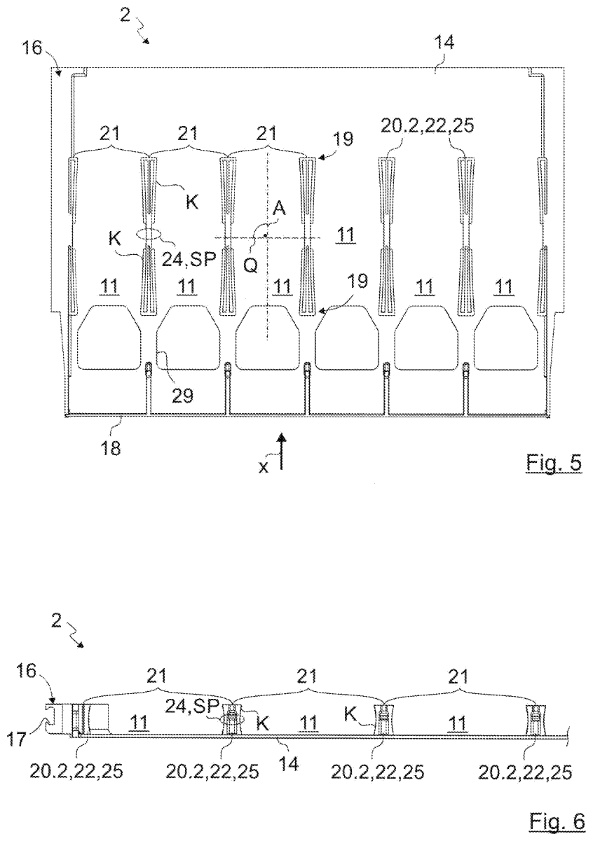

FIG. 5 shows the carrier unit of FIG. 4 in a top view;

FIG. 6 shows the carrier unit of FIG. 4 in a front view of the front interface;

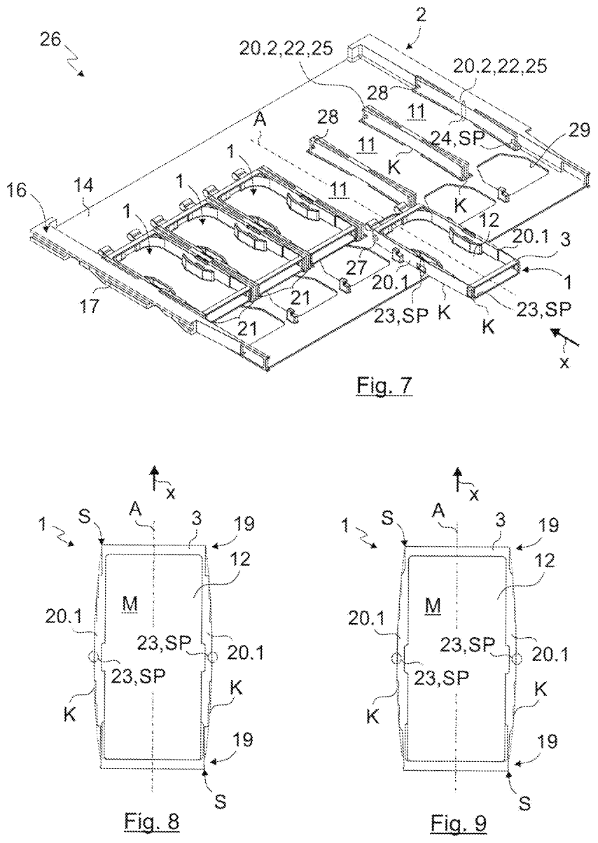

FIG. 7 shows a perspective illustration of a carrier arrangement consisting of a carrier unit and a plurality of module assemblies;

FIG. 8 shows an outer housing of a module assembly according to a further exemplary embodiment of the invention, with a multi-step profile of the side walls, in a top view;

FIG. 9 shows an outer housing of a module assembly according to a further exemplary embodiment of the invention, having a polygonal, wavy curve profile of the side walls, in a top view;

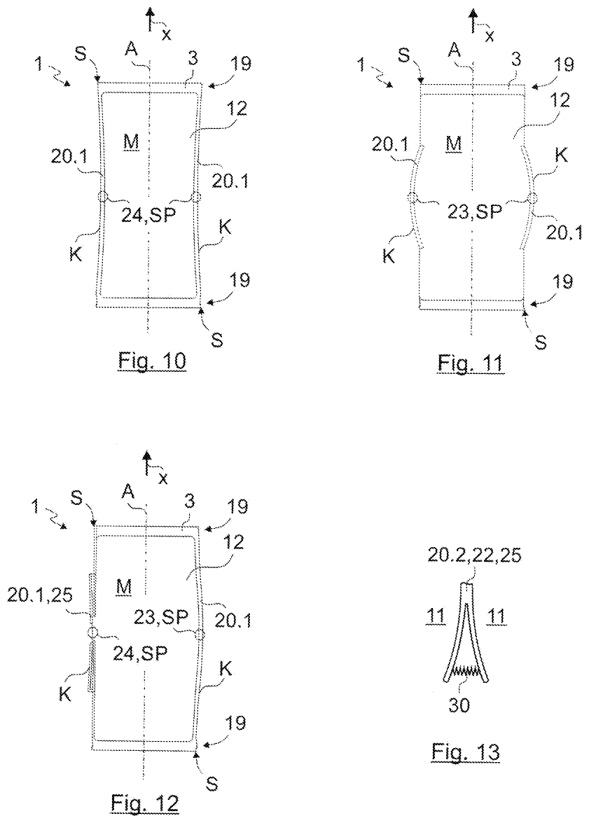

FIG. 10 shows an outer housing of a module assembly according to a further exemplary embodiment of the invention, with a concave profile of the side walls, in a top view;

FIG. 11 shows an outer housing of a module assembly according to a further exemplary embodiment of the invention, with a central arrangement of side wall segments, in a top view;

FIG. 12 shows an outer housing of a module assembly according to a further exemplary embodiment of the invention, with differently designed side walls, wherein one of the side walls has an elastic spring element, in a top view; and

FIG. 13 shows a fastening bracket arranged between two slots in a carrier unit with an additional spring element for increasing the spring force.

FIGS. 1 to 3 show an exemplary embodiment of a module assembly 1 according to the invention in different views. The module assembly 1 is provided for mounting in a carrier unit 2 for the fiber-optic distribution industry, said carrier unit being shown by way of example in FIGS. 4 to 7. The module assembly 1 has an outer housing 3 for fastening in the carrier unit 2.

The module assembly 1 has a front interface 6 with a plurality of first optical connectors 6 and a rear interface 7 with a second optical connector 8. The first connectors 6 can be grouped individually or within connector modules 9, as shown. Optionally, actuating elements 10 are also arranged on the rear interface 7 to facilitate the handling of the module assembly 1 by the engineer during the mounting.

The outer housing 3 of the module assembly 1 is designed to be able to be mounted in a slot 11 (see, for example, FIGS. 4 and 7) of the carrier unit 2. The outer housing 3 has a base plate 12 and optionally a cover plate 13 to protect the fiber-optic components (not shown) within the module assembly 1.

The carrier unit 2, which is shown by way of example in FIGS. 4 to 7, has a carrier plate 14 and a plurality of slots 11 for the mounting of a plurality of module assemblies 1.

In the exemplary embodiments, the carrier plate 14 is designed by way of example as a tray and has a mounting frame 16, which comprises a rail guide system 17 on the outer wall. The carrier unit 2 is accessible at the rear and front, with, for example, a covering of the front and/or rear also being able to be provided as required. By way of example, FIG. 4 illustrates a pivotable covering 18 for the front interface of the carrier unit 2.

The outer housing 3 of the module assembly 1 in each case has two end portions 19 and two side walls 20.1 extending on opposite sides between the two end portions 19. The side walls 20.1 of the module assembly 1 are each assigned to a side region S, wherein the side regions S in each case laterally adjoin a center region M arranged between the two side regions S. The center region M is preferably used for receiving the fiber-optic components and can in principle be a preferably symmetrical, imaginary central portion of the module assembly 1. A center axis A oriented in the mounting direction x and preferably being a longitudinal axis of the module assembly 1 runs through the center region M.

The slots 11 in the carrier unit 2 each have two end portions 19 and two side walls 20.2 extending on opposite sides between the two end portions 19. A center axis A oriented in the mounting direction x extends through the slot 11. The carrier unit 2 also has in each case a fastening device 21, which is connected to the carrier plate 14, for the form-fitting fastening of the module assembly 1 in the at least one slot 11. The fastening devices 21 each have two fastening brackets 22, to which the side wall 20.2 directed into the slot 11 in each case is assigned.

The fastening brackets 22 and the carrier-side side walls 20.2 can be formed in each case in multiple parts with the carrier plate 14. In this case, the fastening brackets 22 can be fastened to the carrier plate 14 (on the upper side of the carrier plate 14, as illustrated in the figures, or alternatively also on the lower side of the carrier plate 14). For example, the fastening brackets 22 can be latched on or under the carrier plate 14. In principle, however, an integral variant can also be provided in which the fastening brackets 22 and the carrier plate 14 are formed monolithically.

As already mentioned above, in addition to the carrier plate 14, the carrier unit 2 can optionally also have a cover plate in order to protect the module assemblies 1 received in the carrier unit 2. In this case, it can also be provided that one of the fastening brackets 22 or both fastening brackets 22 are connected integrally or in multiple parts to the cover plate (less preferred).

At least one of the side walls 20.1, 20.2, in the exemplary embodiments both side walls 20.1, 20.2, has/have, at least in certain sections along the center axis A, a curvy and/or multi-step profile changing the lateral distance d from the center axis A such that the at least one side wall 20 1, 20.2 forms at least one elevation 23 and/or one depression 24 for a form-fitting mounting.

The side walls 20.1, 20.2 therefore preferably at least substantially follow, along at least one direction of extent L, H (cf. FIGS. 1 and 4), an imaginary, curved curve K (cf., for example, FIG. 8). The amplitude of the curved curve K in each case influences the distance d (cf. FIGS. 1 and 4) of the corresponding side wall 20.1. 20.2 from the center axis A. A primary vertex SP of a global extremity of the curved curve K can be formed between the end portions 19 of the side walls 20.1, 20.2.

Even though, in the exemplary embodiment of FIGS. 1 to 7, the primary vertex SP or the global extremity of the curved curve K is substantially centered between the two end portions 19, this is not necessarily required. In principle, any desired curve profile of the side walls 20.1, 20.2 can be provided, in particular even a profile with a plurality of local extremities or with a plurality of radii r_{1,2}. For example, different radii_{1,2} are also provided for the formation of the profile of the side walls 20.1, 20.2 according to the exemplary embodiment of FIGS. 1 to 7 (cf. FIG. 1).

In the exemplary embodiments, the side walls 20.1, 20.2 have a substantially flat profile. In the exemplary embodiments, the directions of extent, along which the side wall 20 1. 20.2 follows the curved curve K, are a longitudinal extent L of the side walls 20.1, 20.2 between the two end portions 19 and an extent in the direction of an overall height H of the module assembly 1 (cf. in particular FIG. 3).

The fastening brackets 22 and/or the side walls 20.2 of the carrier unit 2 (cf. FIGS. 4 to 7) have respective elastically acting spring elements 25, in particular leaf springs. In principle, the side walls 20.1 of the module assembly 1 can also be designed as spring elements 25 (cf. FIG. 12). The preferred variant, in which only the carrier unit 2 has spring elements 25, is shown in FIGS. 1 to 11.

The slots 11 are arranged on the carrier plate 14 of the carrier unit 2 at equidistant spacing and each with the same slot width, wherein two directly adjacent slots 11 each have a common side wall 20.2—which, however, does not necessarily have to be the case.

The slots 11 in the carrier unit 2 are each designed to allow mounting of the module assembly 1 in the horizontal direction along the carrier plate 14 (i.e. from the front and/or from the rear) and also to allow mounting in the vertical direction in the direction of the carrier plate 14 (i.e. from above). The slots 11 in the carrier unit 2 therefore each comprise only the side walls 20.2, the side walls 20.2 not being connected to one other at the end portions 19, and also a cover plate is not provided on the side facing away from the carrier plate 14.

A carrier arrangement 26 consisting of a carrier unit 2 and a plurality of module assemblies 1 is indicated by way of example in FIG. 7, wherein for simplification only the respective outer housing 3 of the module assembly 1 is shown. Also in subsequent FIGS. 8 to 12, the outer housing 3 is shown for easier representation in each case without the other components of the module assembly 1.

The side walls 20.1 of the module assembly 1 have at least substantially a complementary shape of the side walls 20.2 and of the fastening brackets 22 of the carrier unit 2 such that, in its mounted state, the outer housing 3 of the module assembly 1 is received in a form-fitting manner within the slot 11. FIG. 7 illustrates by way of example three module assemblies 1 mounted in a form-fitting manner in the carrier unit 2.

It can be provided in particular that
a) at least one of the side regions S of the module assembly 1 is formed rigidly and at least one of the fastening brackets 22 of the carrier unit 2 is formed elastically such that the side regions S of the module assembly 1 and the fastening brackets 22 interact with each other in such a way as to apply an axial clamping force F_{K} to the module assembly 1, which clamping force acts in the direction of a transverse axis Q (cf. FIG. 5) which runs perpendicular to the center axis A of the slot 11 and which extends laterally through the slot 11 between the fastening brackets 22; or
b) at least one of the side regions S of the module assembly 1 is formed elastically and at least one of the fastening brackets 22 of the carrier unit 2 is formed rigidly such that the side regions S of the module assembly 1 and the fastening brackets 22 interact with each other in such a way as to apply an axial clamping force F_{K} to the module assembly 1, which clamping force acts in the direction of a transverse axis Q which runs perpendicular to the center axis A of the slot 11 and which extends laterally through the slot 11 between the fastening brackets 22.

The axial clamping force F_{K} is indicated by way of example in FIG. 1. In addition, as a supplement, a lateral or radial clamping force F_{L} also acts in the direction of the center axis A (cf. FIG. 1 too). The division of the spring force between the axial clamping force F_{K} and the lateral clamping force F_{L} can be varied along the longitudinal axis A of the module assembly 1 or the center axis A of the slot 11, with the axial clamping force F_{K} in the center of the slot 11 preferably being smaller than at the end portions (or not being present at all).

Optionally, it can be provided that the module assembly 1 has a latching means 27 and the carrier unit 2 a mating latching means 28 in order to releasably latch the module assembly 1 within the slot 11 in at least one insertion position (e.g. in the fully inserted position). In the exemplary embodiment shown in FIG. 7, the latching means 27 is designed as a recess within the side walls 20.1 of the module assembly 1 and the mating latching means 28 as a latching lug of the side walls 20.2 and/or spring elements 25 of the carrier unit 2. Optionally, a plurality of latching means 27 and/or mating latching means 28 can also be provided in order optionally to releasably secure the module assembly 1 in a plurality of pull-out or insertion positions within the carrier unit 2. In a preferred variant, latching means 27 and mating latching means 28 are each arranged at least substantially centrally between the two end portions 19, for example at the vertex SP of the respective imaginary curve K.

In the carrier plate 14 of the carrier unit 2, openings 29 can preferably be formed directly in front of and/or behind the slots 11. By way of example, in the region of the front interface of the carrier unit 2, openings 29 assigned to the respective slots 11 are formed in the carrier plate 14. Corresponding openings 29 can also be arranged in principle, however, in the rear region of the carrier unit 2. The module assemblies 1 can be easier for an engineer to mount and remove through the openings 29. For example, a module assembly 1 mounted in a slot 11 can be gripped well with one hand because of the opening 29, in order then to be pulled out of the slot 11 with sufficient force counter to the spring forces and/or an optional latching.

In the carrier plate 14 of the carrier unit 2, additional recesses or openings or channels (not shown) can optionally also be formed for the passage of fiber-optic lines (for example, in the region of the front interface of the carrier unit 2 and/or in the rear region of the carrier unit 2).

With reference to FIGS. 8 to 12, some examples of possible geometries of the outer housing 3 of the module assembly 1—and thus also of the slots 11 corresponding to corresponding carrier units 2—are to be demonstrated.

In the exemplary embodiment of FIGS. 1 to 7, the side wall 20.1 has a continuous, curved profile or uniformly follows an imaginary, curved curve K. However, as shown in FIG. 8, it may also be provided that the side wall 20.1 of the module assembly 1 has a multi-step profile, that is, follows the curve K step by step, wherein preferably an as large a correspondence as possible between the profile of the side wall 20.1 and the imaginary, curved curve K is provided, i.e. in particular as many points of contact and/or intersecting points as possible.

The side wall 20.1 can have any desired stepped or polygonal shape. For example, the wavy portions can also be provided for approximation to the imaginary curve K, as shown in FIG. 9.

In a preferred variant, the outer housing 3 of the module assembly 1 runs convexly and the slots 11 in the carrier unit 2 run concavely, as shown in the exemplary embodiment of FIGS. 1 to 7. Alternatively, however, it can also be provided that the outer housing 3 of the module assembly 1 runs convexly and the slot 11 in the carrier unit 2 runs concavely, as shown in FIG. 10.

Furthermore, the side walls 20.1 of the module assembly 1 according to FIGS. 1 to 7 extend completely between the two ends of the module assembly 1, but in principle only an extent in certain sections between the end portions 19 may also be sufficient, i.e. also a profile spaced apart from the ends, as shown in FIG. 11. The side walls 20.1 of the module assembly 1 of FIG. 11 therefore do not extend to the respective ends and are arranged in a central portion along the center axis A on the base plate 12 of the outer housing 3 of the module assembly 1.

It should be mentioned at this juncture that the side walls 20.1 of the module assembly 1 can in principle also be segmented or formed in multiple parts. Thus, in particular along the center axis A, a plurality of interrupted and optionally also spaced-apart side wall segments can be provided, which overall in turn form a common “side wall” 20.1, which has the intended curvy and/or multi-step profile. In the same way, the side walls 20.2 of the slot 11 in the carrier unit 2 can also be interrupted, in particular also if the side walls 20.2 of the carrier unit 2 are designed as spring elements 25 or have spring elements 25. In particular, in this case, a plurality of spring elements 25 can be arranged offset along the center axis A.

With reference to the exemplary embodiment of FIG. 12, it should finally also be clarified that the profile of the two side walls 20.1 of a common module assembly 1 does not have to correspond or be formed running mirror-symmetrically to the center axis A. FIG. 12 shows by way of example an outer housing 3, in which one of the side walls 20.1 is formed from a concave spring element 25 and the other side wall 20.1 from a convex wall. The module assembly 1 can therefore be inserted, for example, into a slot 11, which has a concave depression 24 on one side of the center axis A (in the mounting direction x on the right side), preferably with a spring element 25, and on the opposite side of the center axis A a convex elevation 23, preferably without a spring element 25. The elastic components for the force-fitting connection can thus also be divided between slot 11 and outer housing 3 of the module assembly 1.

FIG. 13 shows a variant of the invention in which the spring force of the spring elements 25 of a fastening bracket 22 of a carrier unit 2 has been increased. The fastening bracket 22 shown is arranged between two slots 11 and has a spring element 25 used by both slots 11. On one or both end portions of the spring element 25, an additional spring element 30 can optionally be provided for increasing the spring force in the direction of the center axis A. The additional spring element 30 can be, for example, a coil spring.

1. A module assembly (1) for the fiber-optic distribution industry, which can be mounted along a mounting direction (x) in a slot (11) defined in a carrier unit (2), the module assembly (1) comprising:
an outer housing (3) for fastening in the carrier unit (2), the outer housing (3) having,
a center region (M) through which a center axis (A) oriented in the mounting direction (x) runs, and
two side regions (S), each of which is connected to the center region (M) opposite one another relative to the center axis (A), and
each of the two side regions (S) has a side wall (20.1), and at least one of the side walls (20.1) has, at least in certain sections along the center axis (A), a curvy and/or multi-step profile, and wherein
the curvy and/or multi-step profile of the at least one of the side walls (20.1) changes a lateral distance (d) of the respective side wall (20.1) from the center axis (A); and
the curvy and/or multi-step profile of the at least one side wall (20.1) forms at least one elevation and/or depression (23, 24, SP) for form-fitting mounting of the outer housing (3) of the module assembly (1) in the slot (11) defined in the carrier unit (2); and
each of the side walls (20.1) has a direction of extent (L) and has a direction of extent (H); and
at least one of the side walls (20.1) along at least one of its directions of extent (L, H) substantially follows an imaginary curved curve (K) that has an amplitude, and the amplitude of imaginary curved curve (K) influences the distance (d) of the corresponding side wall (20.1) from the center axis (A); and
at least one of the side walls (20.1) has at least four points of contact and/or Intersecting points with the imaginary curved curve (K); and wherein
at least one of the side regions (S) of the outer housing (3) is formed rigidly and the respective rigid side region (S) interacts with elastically formed, lateral fastening brackets (22) of the slot (11) defined in the carrier unit (2) or at least one of the side regions (S) of the outer housing (3) is formed elastically and the respective elastic side region (S) interacts with rigidly formed, lateral fastening brackets (22) of the slot (11) in the carrier unit (2); and
the interaction of the respective side regions (S) with the respective lateral fastening brackets (22) applies an axial clamping force (F_{K}) to the module assembly (1), and the said axial clamping force (F_{K}) acts in a direction of a transverse axis (Q) which runs perpendicular to the center axis (A) of the slot (11) and the transverse axis (Q) extends laterally through the slot (11) between the lateral fastening brackets (22).

2. The module assembly (1) as claimed in claim 1, and wherein the transverse axis (Q) runs through a center of the slot (11).

3. The module assembly (1) as claimed in claim 1 and wherein a spring force emanating from the elastically formed side regions (S) is oriented more specifically in the direction of the axial clamping force (F_{K}) at an end portion (19) of the side regions (S) than in a central portion.

4. The module assembly (1) as claimed in claim 1 and further comprising:
a spring element extending along the corresponding side wall (20.1) of at least one of the elastically formed side regions (S) of the module assembly (1).

5. The module assembly (1) as claimed in claim 4, and wherein the spring element is composed of a plurality of individual springs arranged along the side wall (20.1) of the module assembly (1).

6. The module assembly (1) as claimed in claim 1 and wherein at least one elevation and/or depression (23, 24, SP) is formed in a central portion of the respective side wall (20.1, 20.2) and is spaced apart from the end portions (19) of the respective side walls (20.1, 20.2).

7. The module assembly (1) as claimed in claim 1 and wherein the at least one side wall (20.1, 20.2) for changing the lateral distance (d) along the center axis (A) has a continuous profile.

8. The module assembly (1) as claimed in claim 1 and wherein the elevation and/or depression is formed by at least one vertex or one saddle point (SP) of the curvy profile.

9. The module assembly (1) as claimed in claim 1 and wherein the at least one side wall (20.1, 20.2) forms an elliptical profile, or a concave profile, or a convex profile, in a direction orthogonal to the mounting direction (x).

10. The module assembly (1) as claimed in claim 1 and wherein the lateral distance (d) of the at least one side wall (20.1. 20.2) from the center axis (A) changes along the mounting direction (x) and also changes transversely with respect to the mounting direction (x).

11. A carrier unit (2) for the fiber-optic distribution industry, comprising:
a carrier plate (14), which has at least one slot (11) for at least one module assembly (1); and wherein
each at least one slot (11) has a center axis (A) oriented in a mounting direction (x) of the at least one module assembly (1); and
a fastening device (21) connected to the carrier plate (14) for form-fitting fastening of the at least one module assembly (1) in the at least one slot (11); and wherein
the fastening device (21) has two fastening brackets (22), which are each formed at a lateral end of the at least one slot (11) relative to the center axis (A); and wherein
each of the two fastening brackets (22) has a side wall (20.2) facing into the at least one slot (11), and each side wall (20.2) has a direction of extent (L), and each side wall (20.2) has a direction of extent (H); and wherein
at least one of the side walls (20.2) has, at least in certain sections along the center axis (A), a curvy and/or multi-step profile changing a lateral distance (d) of the side wall (20.2) from the center axis (A) such that the side wall (20.2) forms at least one elevation and/or at least one depression (23, 24, SP) for form-fitting mounting of the at least one module assembly (1) in the at least one slot (11); and wherein
at least one of the side walls (20.2) along at least one of its directions of extent (L, H) substantially follows an imaginary curved curve (K) that has an amplitude, and the amplitude of the imaginary curved curve (K) influences the distance (d) of the corresponding side wall (20.2) from the center axis (A); and wherein
the side wall (20.2) has at least four points of contact and/or intersecting points with the imaginary curved curve (K); and wherein
at least one of the two fastening brackets (22) is formed rigidly and the at least one rigidly formed fastening bracket (22) interacts with elastically formed side regions (S) of the at least one module assembly (1), or at least one of the two fastening brackets (22) is formed elastically and the at least one elastically formed fastening bracket (22) interacts with rigidly formed side regions (S) of the at least one module assembly (1); and
the interaction of the respective fastening brackets (22) with the respective side regions (S) of the at least one module assembly (1) applies an axial clamping force (F_{K}) to the at least one module assembly (1), and the said axial clamping force (F_{K}) acts in a direction of a transverse axis (Q) which runs perpendicular to the center axis (A) of the at least one slot (11) and the transverse axis (Q) extends laterally through the at least one slot (11) between the fastening brackets (22).

12. The carrier unit (2) as claimed in claim 11, and wherein the transverse axis (Q) runs through a center of the at least one slot (11).

13. The carrier unit (2) as claimed in claim 11 and wherein a spring force emanating from the elastically formed fastening brackets (22) is oriented more specifically in the direction of the axial clamping force (F_{K}) at an end portion of the respective elastically formed fastening bracket (22) than in a central portion.

14. The carrier unit (2) as claimed in claim 11 and further comprising:
a spring element (25) in at least one of the elastically formed fastening brackets (22) extending along the corresponding side wall (20.2).

15. The carrier unit (2) as claimed in claim 14, and wherein the spring element (25) is composed of a plurality of individual springs arranged along the side wall (20.2).

16. The carrier unit (2) as claimed in claim 11 and wherein the at least one slot (11) allows the at least one module assembly (1) to be mounted in the horizontal direction along the carrier plate (14), and/or allows the at least one module assembly (1) to be mounted in a vertical direction, towards the carrier plate (14).

17. The carrier unit (2) as claimed in claim 11 and wherein the fastening device (21) is formed integrally with the carrier plate (14) or the fastening device (21 is fastened to the carrier plate (14).

18. A carrier arrangement (26), comprising:
a carrier unit (2) comprising:
a carrier plate (14), which has at least one slot (11) for at least one module assembly (1), and
each at least one slot (11) has a center axis (A) oriented in a mounting direction (x) of the at least one module assembly (1), and
a fastening device (21) connected to the carrier plate (14) for the form-fitting fastening of the at least one module assembly (1) in the at least one slot (11), and
the fastening device (21) has two fastening brackets (22), which are each formed at a lateral end of the at least one slot (11) relative to the center axis (A), and
each fastening bracket (22) has a side wall (20.2) facing into the at least one slot (11), and each side wall (20.2) has a direction of extent (L), and each side wall (20.2) has a direction of extent (H), and
at least one of the side walls (20.2) has, at least in certain sections along the center axis (A), a curvy and/or multi-step profile changing a lateral distance (d) of the at least one side wall (20.2) from the center axis (A) such that the at least one side wall (20.2) forms at least one elevation and/or at least one depression (23, 24, SP) for form-fitting mounting of the at least one module assembly (1) in the at least one slot (11), and
at least one of the side walls (20.2), along at least one of its directions of extent (L, H), substantially follows an imaginary curved curve (K) that has an amplitude, and the amplitude of the imaginary curved curve (K) influences the distance (d) of the corresponding side wall (20.2) from the center axis (A), and
the side wall (20.2) has at least four points of contact and/or intersecting points with the imaginary curved curve (K), and
at least one of the two fastening brackets (22) is formed rigidly and the at least one rigidly formed fastening bracket (22) interacts with elastically formed side regions (S) of the at least one module assembly (1), or at least one of the two fastening brackets (22) is formed elastically and the at least one elastically formed fastening bracket (22) interacts with rigidly formed side regions (S) of the at least one module assembly (1), and
the interaction of the respective fastening brackets (22) with the respective side regions (S) of the at least one module assembly (1) applies an axial clamping force (F_{K}) to the at least one module assembly (1), and the said axial clamping force (F_{K}) acts in a direction of a transverse axis (Q) which runs perpendicular to the center axis (A) of the at least one slot (11) and the transverse axis (Q) extends laterally through the at least one slot (11) between the two fastening brackets (22); and
the at least one module assembly (1), which is mounted in one of the slots (11), defined in the carrier plate (14) comprises:
an outer housing (3) for fastening in the carrier unit (2), the outer housing (3) having,
a center region (M) through which a center axis (A) oriented in the mounting direction (x) runs, and
two side regions (S), each of which is connected to the center region (M) opposite one another relative to the center axis (A), and
each of the two side regions (S) has a side wall (20.1), and at least one of the side walls (20.1) has, at least in certain sections along the center axis (A), a curvy and/or multi-step profile, and wherein
the curvy and/or multi-step profile of the at least one of the side walls (20.1) changes a lateral distance (d) of the respective side wall (20.1) from the center axis (A), and
the curvy and/or multi-step profile of the at least one side wall (20.1) forms at least one elevation and/or depression (23, 24, SP) for form-fitting mounting of the outer housing (3) of the module assembly (1) in the slot (11) defined in the carrier unit (2), and
each of the side walls (20.1) defines a direction of extent (L) and has a direction of extent (H), and
at least one of the side walls (20.1) along at least one of its directions of extent (L, H) substantially follows an imaginary curved curve (K) that has an amplitude, and the amplitude of imaginary curved curve (K) influences the distance (d) of the corresponding side wall (20.1) from the center axis (A), and
the at least one side wall (20.1) has at least four points of contact and/or intersecting points with the imaginary curved curve (K), and wherein
at least one of the side regions (S) of the outer housing (3) is formed rigidly and the respective rigid side region (S) interacts with elastically formed, lateral fastening brackets (22) of the slot (11) defined in the carrier unit (2) or at least one of the side regions (S) of the outer housing (3) is formed elastically and the respective elastic side region (S) interacts with rigidly formed, lateral fastening brackets (22) of the slot (11) defined in the carrier unit (2), and
the interaction of the respective side regions (S) with the respective lateral fastening brackets (22) applies an axial clamping force (F_{K}) to the module assembly (1), and the said axial clamping force (F_{K}) acts in a direction of a transverse axis (Q) which runs perpendicular to the center axis (A) of the slot (11) and the transverse axis (Q) extends laterally through the slot (11) between the lateral fastening brackets (22); and
the side walls (20.1) of the at least one module assembly (1) have a complementary shape of the side wall (20.2) of the respective fastening bracket (22) so that the at least one module assembly (1), in its mounted state, is accommodated in a form-fitting manner within the fastening device (21) of the carrier plate (14).

19. The carrier arrangement (26) as claimed in claim 18, and wherein either the side region (S) of the module assembly (1) or the fastening bracket (22), which is assigned to the side region (S), of the fastening device (21) is elastic.

20. The carrier arrangement (26) as claimed in claim 18 and wherein a slot width of the at least one slot (11) is greater than a width of the at least one module assembly (1).

21. The carrier arrangement (26) as claimed in claim 18 and further comprising:
a module assembly (1) latching means (27); and
the fastening device (21) of the carrier unit (2) has a mating latching means (28) to releasably latch the module assembly (1) in at least one insertion position within the fastening device (21).

22. The carrier arrangement (26) as claimed in claim 18 and wherein at least one of the side regions (S) of the at least one module assembly (1) and/or at least one of the fastening brackets (22) of the fastening device (21) automatically brings about centering of the at least one module assembly (1) within the at least one slot (11) by elastic restoring forces as the at least one module assembly (1) is being introduced into the at least one slot (11).
